(19) United States
(12) Patent Application Publication
(10) Pub. No.: US 2021/0162960 A1
(43) Pub. Date: Jun. 3, 2021

(54) AUTOMOBILE RIM AND TIRE BRUSH DEVICE

(71) Applicant: Wayne Waters, Virginia Beach, VA (US)

(72) Inventor: Wayne Waters, Virginia Beach, VA (US)

(21) Appl. No.: 17/086,929

(22) Filed: Nov. 2, 2020

Related U.S. Application Data
(60) Provisional application No. 62/942,212, filed on Dec. 2, 2019.

(51) Int. Cl. B60S 3/04; A46B 13/02

(52) U.S. Cl. CPC B60S 3/042; A46B 2200/3046; A46B 13/02; B60S 3/048

(57) ABSTRACT

An automobile rim and tire brush device including a handle, a power button, an attachment unit, a first detachable brush head and a second detachable brush head. The handle including a cavity for enclosing a battery operated motor which is configured to initiate a spinning motion of an attached brush head. The power button positioned at a distal end of the handle, the power button is configured to actuate the battery operated motor. The attachment unit positioned at proximate end of the handle, the attachment unit is configured to receive a detachable brush head. The first detachable brush head having a triangular shape with a pointed tip, the first detachable brush head configured to fit in and clean tight spaces. The second detachable brush head having a circular shape, the second brush head configured to clean a surface of an object.

### CROSS-REFERENCE TO RELATED APPLICATIONS

This application claims the benefit of priority of U.S. Provisional Application No. 62/942,212 filed on Dec. 2, 2019, the disclosure of which is incorporated herein by reference in its entirety.

### FIELD OF THE INVENTION

Embodiments described herein generally relate to cleaning brushes, and more particularly to a tire and rim cleaning brush.

### BACKGROUND OF THE INVENTION

Tire maintenance is a major component vehicle care and automobile preservation. However, many vehicle owners experience challenges and difficulty when trying to clean debris from the crevices of tires and rims. This results in cracks in the rubber and an unsightly appearance. Hence, an efficient means of cleaning debris from the crevices of tires and rims is desirable.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view of an automobile rim and tire brush device according to an embodiment of the present disclosure.

FIG. 2 shows another exemplary view of an automobile rim and tire brush device according to an embodiment of the present disclosure.

### SUMMARY OF THE INVENTION

The present disclosure describes an automobile rim and tire brush device. The automobile rim and tire brush device including a handle, a power button, an attachment unit, a first detachable brush head and a second detachable brush head. The handle including a cavity for enclosing a battery operated motor which is configured to initiate a spinning motion of an attached brush head. The power button positioned at a distal end of the handle, the power button is configured to actuate the battery operated motor. The attachment unit positioned at proximate end of the handle, the attachment unit is configured to receive a detachable brush head. The first detachable brush head having a triangular shape with a pointed tip, the first detachable brush head configured to fit in and clean tight spaces. The second detachable brush head having a circular shape, the second brush head configured to clean a surface of an object.

In some exemplary embodiments, the first detachable brush head has a soft surface.

In some exemplary embodiments, the second detachable has a hard surface.

In some exemplary embodiments, the first detachable brush head is configured to clean an automobile rim.

In some exemplary embodiments, the second detachable brush head is configured to clean an automobile tire.

### DETAILED DESCRIPTION

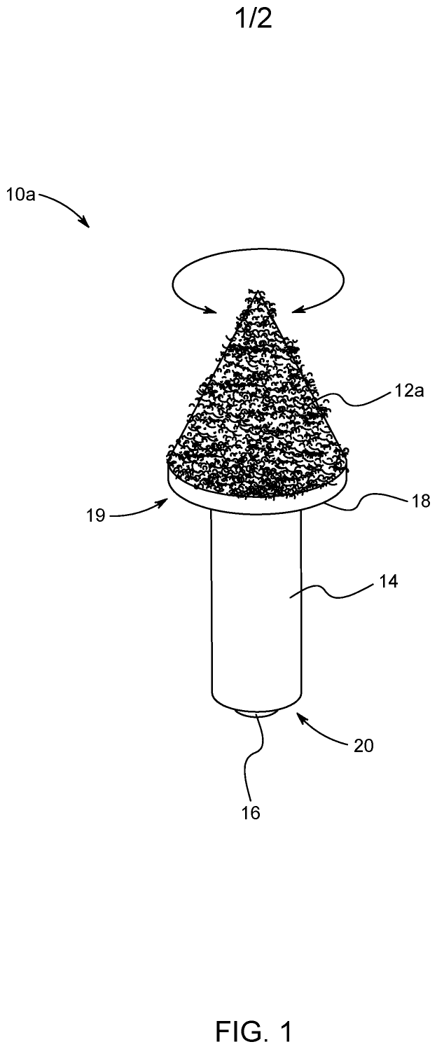

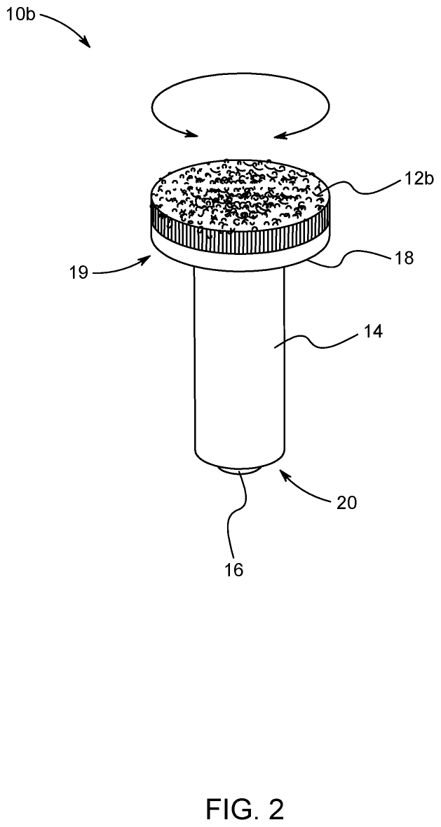

The present disclosure relates to an automobile rim and tire brush device (“the device”) that spins when activated. Unlike most tire brushes that are traditionally stagnant and manually operated by the user, the present device spins and is powered by batteries. The device includes detachable components having different shapes to ensure proper maintenance of the rim and tire. As illustrated in FIGS. 1-2, the device 10 includes a rotational brush head 12, a handle 14, a power button 16 and an attachment unit 18. The device 10 includes two detachable spinning brush head components 12a and 12b for thorough cleaning of the rim and the tire. In FIG. 1, the device (10a) is shown with a first detachable brush head (12a). In FIG. 2, the device (10b) is shown with a second detachable brush head (12b).

The handle 14 includes a cavity for enclosing a battery operated motor which is configured to initiate a spinning motion of an attached brush head. The power button 16 is positioned at a distal end 20 of the handle and is configured to actuate the battery operated motor to initiate the spinning motion of an attached brush head. The attachment unit 18 is positioned at a proximate end 19 of the handle 14 and is configured to receive a detachable brush head 12. The attachment unit allows for the selective attachment or removal of a detachable brush head. The attachment unit is connected to the battery operated motor.

The attachment unit may include a motor bracket or a motor connector which is configured to mate with the bottom of a detachable brush head thereby connecting the detachable brush head to the handle. In embodiments, the detachable brush head 12 and the attachment unit 18 may include a locking collar and a mating slot portion (stationary portion) respectively, wherein the locking collar is slidably or rotatable couplable to the mating slot portion so as to axially retain the detachable brush head on the attachment unit thereby connecting the detachable brush head to the handle. In other embodiments, the attachment unit may include a shaft which may fit inside an aperture of a detachable brush head and rotatable lock the shaft inside the aperture thereby connecting the detachable brush head to the handle.

One of the detachable brush head components 12a (i.e., a first detachable brush head) may be a cone shape (i.e., having pointed tip) brush head that flairs out of the shaft and having a soft surface (i.e., soft bristles) making it easier to fit in tight spaces to clean the crevices and tight cracks of the rims and tires. The other detachable brush head component 12b (i.e., a second detachable brush head) may have a flat shape brush head (e.g., a circular shape) and a hard surface (i.e., hard bristles) for cleaning debris along the surface of the rims and the tires.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. An automobile rim and tire brush device comprising:
a handle including a cavity for enclosing a battery operated motor which is configured to initiate a spinning motion of an attached brush head;
a power button positioned at a distal end of the handle, the power button is configured to actuate the battery operated motor;
an attachment unit positioned at a proximate end of the handle, the attachment unit is configured to receive a detachable brush head;
a first detachable brush head having a triangular shape with a pointed tip, the first detachable brush head configured to fit in and clean tight spaces; and
a second detachable brush head having a circular shape, the second brush head configured to clean a surface of an object.

2. The device of claim 1, wherein the first detachable brush head has a soft surface.

3. The device of claim 1, wherein the second detachable brush head has a hard surface.

4. The device of claim 1, wherein the first detachable brush head is configured to clean an automobile rim.

5. The device of claim 1, wherein the second detachable brush head is configured to clean an automobile tire.
